(19) United States
(12) Patent Application Publication
(10) Pub. No.: US 2015/0049326 A1
(43) Pub. Date: Feb. 19, 2015

(54) LIGHT DETECTION AND RANGING

(71) Applicant: Applied Energetics Inc., Tucson, AZ (US)

(72) Inventor: Paul B. Lundquist, Vail, AZ (US)

(21) Appl. No.: 13/916,081

(22) Filed: Jun. 12, 2013

Related U.S. Application Data
(60) Provisional application No. 61/658,823, filed on Jun. 12, 2012.

(51) Int. Cl. G01S 7/486; G01S 7/484

(52) U.S. Cl. CPC G01S 7/4865; G01S 7/484
USPC 356/5.01

(57) ABSTRACT

Systems and methods presented herein provide for laser detection and ranging in more than one medium. In one embodiment, a laser is operable to generate and fire laser pulses into a liquid, such as water. The laser pulses form broadband super continuum emissions and/or harmonics in the liquid that propagate optical energy past a surface of the liquid. A detector is operable to receive the optical energy from the liquid, which is then processed to determine a range parameter of the liquid. That is, a processor may determine the depth of the water or an object beneath the surface of the water by measuring the travel times of optical energy reflected from the surface of the liquid and optical energy returned from beneath the surface of the liquid.

### CROSS REFERENCE TO RELATED APPLICATIONS

This patent application claims priority to and thus the benefit of an earlier filing date from U.S. Provisional Patent Application No. 61/658,823 (filed Jun. 12, 2012), the contents of which are hereby incorporated by reference.

### BACKGROUND

LIDAR (Light Detection and Ranging) is an optical remote sensing technology that measures properties of scattered light to find range and/or other information of a distally positioned target. LIDAR generally uses laser pulses to determine distance to an object or surface. Similar to radar technology, which uses radio waves instead of light, a LIDAR system determines a range to an object by measuring the time delay between transmission of a laser pulse and detection of the reflected signal. LIDAR technology has applications in archaeology, geography, geology, geomorphology, seismology, remote sensing and atmospheric physics. Other terms for LIDAR include Airborne Laser Swath Mapping (ALSM), laser altimetry, and Laser Detection and Ranging (LADAR often used in military contexts).

One difference between LIDAR and radar is that with LIDAR, much shorter wavelengths of the electromagnetic spectrum are used, typically in the ultraviolet, visible, or near infrared spectrums. Generally, it is possible to image a feature or object that is about the same size as the wavelength, or larger. For example, an object generally needs to produce a dielectric discontinuity in order to reflect the transmitted wave. At radar frequencies (e.g., microwave), a metallic object produces a significant reflection. However non-metallic objects, such as rain and rocks, produce weaker reflections and some materials may produce no detectable reflection at all meaning some objects or features are effectively invisible at radar frequencies. This is especially true for very small objects, such as single molecules and aerosols. Because light wavelengths are so much smaller, LIDAR is highly sensitive to aerosols and cloud particles and has many applications in atmospheric research and meteorology. Also, a laser typically has a narrow beam which allows the mapping of physical features with very high resolution as compared to radar. And, many chemical compounds interact more strongly at visible wavelengths than at microwaves, resulting in a stronger imaging of these materials.

### SUMMARY OF THE INVENTION

Systems and methods presented herein provide for LIDAR generally using high-intensity ultrashort pulse (USP) lasers, although other lasers may be used. For example, when a high-intensity laser beam travels through a medium, it may experience an increase in the index of refraction that acts as a lens, focusing the beam. The more the laser is focused, the higher the intensity becomes. As this process continues, very high local intensities are generated and regions within the beam can collapse. However, at extreme intensities (e.g., 10¹⁴ watts per square centimeter), a nonlinear process called multiphoton ionization occurs. The molecules in the medium absorb many photons at once, stripping electrons from their parent atoms to form plasma. The resulting plasma densities decrease the local index of refraction, which has the effect of defocusing trailing laser energy. It is this non linear defocusing effect from the laser-generated plasma that arrests the collapse of the beam and can lead to elongated propagation of extreme-intensity features within the laser beam.

This self-focusing effect can be achieved using a high-power USP laser. In an effect known as self-phase modulation, the extreme temporal gradients in a laser pulse's intensity result in temporal phase shifts manifested as the generation of broadband frequency components. Self-focusing effects, angular phase-matching conditions for parametric generation of new optical frequencies, and diffraction may combine to emit a broad bandwidth spectrum both on axis and in a forward-directed cone about the propagation direction of the beam. Generally, the broad-spectrum light is known as a broadband super continuum emission (BSCE) and may have significant spectral components (e.g., extending roughly 200 nm to 1 μm when generated with an 800 nm pulse) that can be used in underwater LIDAR applications.

The invention, however, is not intended to be limited to any particular type of focusing, as higher order nonlinear effects of the medium itself may balance the self-focusing effect. For example, nonlinear mixing processes in water may also be performed without the balanced self-focusing and defocusing process. Accordingly, a laser intensity and duration may be configured based on an identified medium of propagation for the laser. That is, if the medium of propagation is identified, the balancing of the self-focus/defocus parameters operable to form a BSCE may also be known for certain lasers. Thus, the depth of the BSCE formation and its spectral characteristics within the medium may be determined based on the selection of a laser.

It should be noted that the spectral return detected by the LIDAR system is not intended to be limited to just the broadband spectral components of the BSCE. Rather, the spectral return may include certain optical harmonics of the optical energy fired from a laser. For example, as the optical energy of a laser pulse propagates through a medium, it may back scatter optical energy at a harmonic wavelength. To further illustrate, an 800 nm wavelength laser pulse may propagate through the air into water. A portion of the optical energy returning from the water may be at a wavelength of 400 nm or some other harmonic, such as 100 nm. For the purpose of simplicity, the term BSCE is intended to encompass a broad spectrum of optical energy resulting from optical energy from a laser including various harmonics of the optical energy from the laser.

In one embodiment, a LIDAR system includes a laser operable to fire laser pulses into a liquid (e.g., water). The laser pulses are operable to propagate optical energy into the liquid past a surface of the liquid with pulse widths of about 10 femtoseconds or greater and at wavelengths of about 400 nm or greater. In this regard, the laser pulses may be configured for generating a BSCE of optical energy in water that is used to detect targets therein (e.g., torpedoes, submarines, shipwrecks, mines, etc.). In this regard, the system also includes a detector operable to receive optical energy from the liquid in response to firing the laser pulses into the liquid to generate processable data representative thereof. For example, the detector may receive the reflection/return of the optical energy resulting from the laser pulses via backscattering. Although, other types of scattering and/or fluorescence may be observed for different LIDAR applications. Some common scatterings are Rayleigh scattering, Mie scattering, and Raman scattering. From the received optical energy, the detector may generate electronically processable data that is representative of the received optical energy. The detector, or other processor, then processes this data to determine a range parameter of the target in the liquid. For example, the detector may receive optical energy that is reflected from the surface of the liquid as well as optical energy from beneath the surface and measure the travel times of each to determine a distance of the target (or floor) from the laser, in a manner similar to radar. The detector may also be operable to detect and/or identify an object under water using imaging techniques that are similar to radar. That is, the detector may process the received optical energy to determine depth variations of the object and form an image of the object based on repeated LIDAR measurements via individual pulses. The LIDAR system may also include a GPS module to correlate GPS information with the range parameter to generate mapping information.

In another embodiment, an underwater mapping system includes a laser system operable to fire laser pulses that propagate optical energy through water. The spectral return from the water typically has a different wavelength than that reflected from the surface of the water. The detector, in this regard, may also be operable to identify the reflected optical energy based on its wavelength, identify the ensuing generated optical energy based on its wavelength, and then determine the range parameter therefrom. The detector may also be operable to identify a medium based on a wavelength of a spectral return. For example, a wavelength of the spectral return that differs from a initiating laser may indicate a material type. The detector may therefore process the spectral return to identify the material type of the medium.

In another embodiment, a laser detection and ranging system includes a laser operable to fire pulsed optical energy of a first spectrum through a first medium (e.g., air or a gas) to generate optical energy of a second spectrum after passing through a second medium (e.g., another gas, an aerosol, water, etc.). The laser detection and ranging system also includes a detector (e.g., multispectral or hyperspectral) operable to receive the optical energy of the second spectrum from the second medium to determine a range parameter of the second medium based on a time of flight between the pulsed optical energy and the received optical energy. The optical energy of the second spectrum may include broadband continuum emissions and/or harmonics (e.g., a third harmonic). The received optical energy of the second spectrum may alternatively or additionally include spectral attenuation information of the pulsed optical energy.

The pulsed optical energy may be configured as laser pulses having pulse widths of at least 10 femtoseconds. The pulsed optical energy may be configured as laser pulses with pulse widths in a range of about 1.4 um and 1.8 um. The pulsed optical energy may be configured within a wavelength range between about 700 and 900 nm or at least 400 nm or greater.

### BRIEF DESCRIPTION OF THE DRAWINGS

Some embodiments of the present invention are now described by way of example with reference to the accompanying drawings. The same reference number represents the same element or the same type of element on all drawings.

FIG. 1 is a block diagram of an exemplary LIDAR system.

FIG. 2 is a block diagram of the LIDAR system operable to determine a range parameter in two mediums, in one exemplary embodiment.

FIG. 3 is a more detailed block diagram of the LIDAR system operable to determine a range parameter in two mediums, in one exemplary embodiment.

FIG. 4 is a block diagram of the LIDAR system operable to determine a range parameter in water, in one exemplary embodiment.

FIG. 5 is an illustration of the LIDAR system in operation aboard an aircraft, in one exemplary embodiment.

FIG. 6 is another illustration of the LIDAR system in operation aboard an aircraft, in one exemplary embodiment.

FIG. 7 is a block diagram of an experimental LIDAR system.

FIGS. 8-10 are graphs of experimental results of the LIDAR system of FIG. 7.

FIG. 11 is a block diagram of a processing system operable to implement certain features of the various LIDAR systems disclosed herein.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

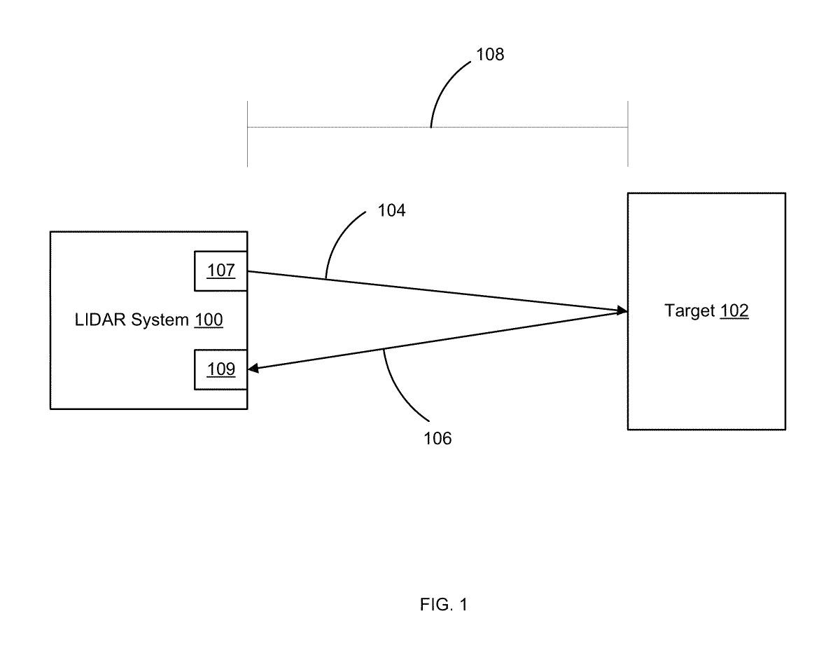

FIG. 1 is a block diagram of an exemplary LIDAR system 100. Generally, the LIDAR system 100 includes a laser 107 that propagates laser pulses to a target 102 for reflection therefrom. For example, the LIDAR system 100 may fire laser pulses along the path 104 to the target 102. The target 102 may reflect optical energy of the laser pulses along the path 106 to a detector 109 of the LIDAR system 100. The LIDAR system 100 may determine a distance 108 by measuring the time it takes for the laser pulse emitted from the LIDAR system 100 to backscatter from the target 102, divided by the speed of light divided by two, or c/2 (where c is the speed of light in a vacuum at 299,792,458 m/s).

Alternatively or additionally, the LIDAR system 100 may receive optical energy from the target 102 that is generated by laser pulses impinging the target. For example, the laser pulses from the LIDAR system 100 may impinge the target 102 and generate a plasma from the material of the target 102. This plasma may emit optical energy that is detectable by the detector 109. In this regard, the LIDAR system 100 may include lasers, optics, electronics (e.g., power supplies and control circuits), and related software that are configured to generate laser pulses that have relatively high optical intensities and relatively short durations (e.g., high-intensity USP laser pulses). The detector 109 may be any device or system operable to detect optical energy and convert the detected optical energy to electronically processable data to determine a range parameter of the target 102 (e.g., the distance 108) based on a time of flight between the fired laser pulse and the detected optical energy. In this regard, the detector 109 may include a processor that, when directed by software instructions, is operable to compute the range parameter. Additionally, the detector 109 may be operable to identify received optical energy of multiple wavelengths (e.g., reflected laser pulses, BSCE, etc.) to determine the range parameter.

In one embodiment, the LIDAR system 100 may be used to remotely sense the depths of a body of water, a process generally referred to as bathymetry. For example, the LIDAR system 100 may remotely sense a body of water by measuring the time it takes for a beam of light emitted from the LIDAR system 100 to return optical energy after encountering the target 102 submerged in the water. By using the relationship between laser pulse travel time and the speed of light traveling through water and air, the LIDAR system 100 may calculate the distance 108 between the LIDAR system 100 and the target 102.

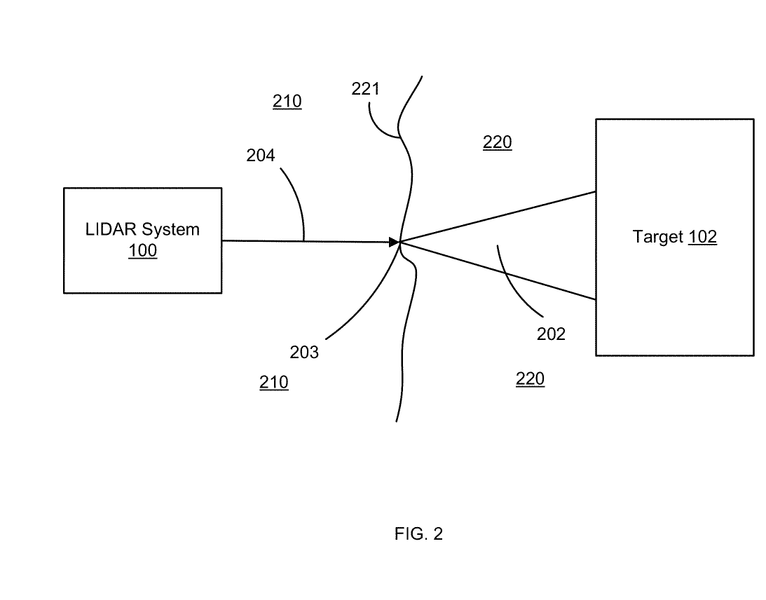

FIG. 2 is a block diagram of the LIDAR system 100 operable to determine a range parameter in two mediums 210 and 220, in one exemplary embodiment. In operation, the LIDAR system 100 may emit a beam 204 of laser pulses in the direction of the target 102. At a certain propagation distance indicated by the reference point 203, a BSCE 202 in the shape of a forward-directed cone about the propagation direction of the beam 204 may be formed. In this embodiment, the reference point 203 is located at the interface 221 of the two mediums 210 and 220. An example of the interface 221 is an interface between two gaseous mediums, such as air (e.g., medium 210) and an aerosol dispersed in the air (e.g., medium 220). Another example of the interface 221 is an interface between air and a liquid, such as water.

The propagation distance may be controlled by varying the parameters of the laser and by taking advantage of linear propagation to manage where intensities are sufficiently high for nonlinear propagation to prevail. For example, in the near field, beam focusing may be used to specify where the beam intensity is sufficient to form the BSCE 202. However, to control such a formation at longer ranges, dispersion control may be used. Dispersion control involves stretching a laser pulse temporally so that relatively long wavelength components trail short wavelength components. By stretching the pulse, the peak laser power is decreased so that the propagation distance required for beam collapse is extended.

In another technique for controlling the location of BSCE 202, the difference in propagation velocities of the different wavelength components may be used for an effect called temporal focusing. To implement this effect, slower short-wavelength components are given a “head start” in the stretched pulse, and faster long-wavelength components catch up with the leading edge of the laser pulse at a predetermined location. This may lead to compression of the pulse at a determinable distance and an increase in peak power, which provides a method to control the placement of the BSCE 202. In this regard, it should be noted that the BSCE 202 may initiate at some point past the interface 221 within the medium 220.

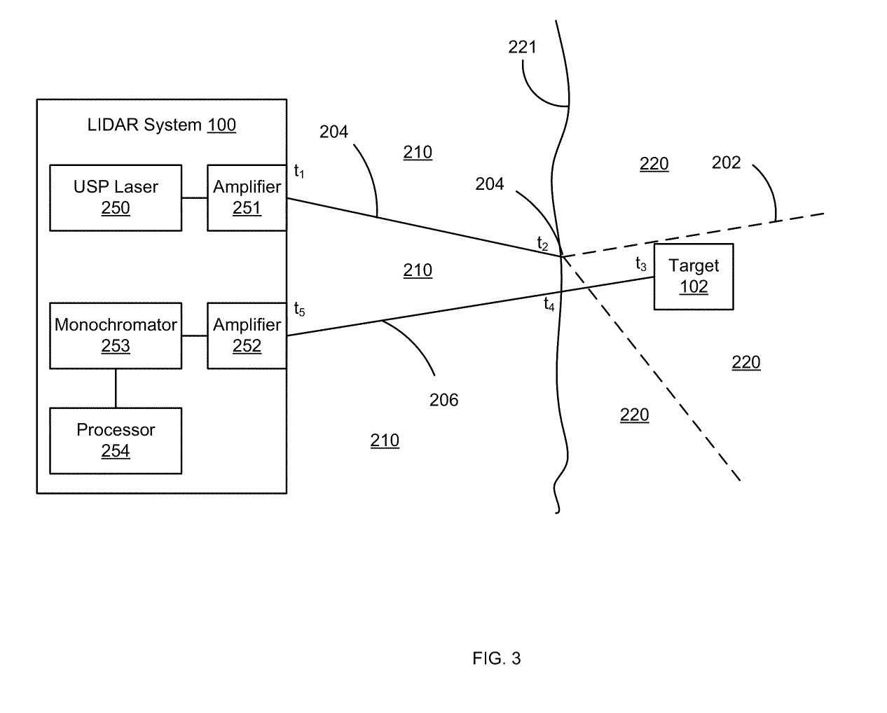

FIG. 3 is a more detailed block diagram of the LIDAR system 100 operable to determine a range parameter in the two mediums 210 and 220, in one exemplary embodiment. In this embodiment, the LIDAR system 100 includes a USP laser 250 with an amplifier 251. The amplifier 251 may be configured in a variety ways to provide USP laser pulses. For example, the amplifier 251 may be a regenerative amplifier or a walk off multipass amplifier (WOMPA) as disclosed in the commonly owned and co-pending U.S. patent application Ser. No. 11/970,916 (filed Jan. 8, 2008), Ser. No. 12/954,308 (filed Nov. 24, 2010; the “'308 application”), and Ser. No. 12/954,329 (filed Nov. 24, 2010; the “'329 application”) the entire contents of each of which are hereby incorporated by reference. The LIDAR system 100 may also include an amplifier 252 for receiving the reflected optical energy and/or the BSCE 202 resulting from the fired laser pulses 204. The amplifier 252 may amplify the received optical energy 206 such that a monochromator 253 (or other form of optical energy detector, such as an image spectrometer) may convert the received optical energy 206 into electronically processable data for processing by a processor 254. In one embodiment, the amplifier 252 is a WOMPA system as disclosed in the '308 and the '329 applications.

FIG. 3 also illustrates a time of flight for the laser energy. For example, the LIDAR system 100 may generate/amplify a laser pulse and then emit that laser pulse at a time t₁ for propagation along the path 204 through the medium 210. When the optical energy of the laser pulse breaches the interface 221 between the two mediums 210 and 220, the optical energy may form a BSCE 202 at a time t₂ within the medium 220. However, the speed of light changes (e.g., “slows down”) in the medium 220. Accordingly, the distance that the optical energy travels cannot be calculated simply by taking the total amount of time between the firing of the laser pulse and the spectral return. Rather, the distance from the LIDAR system to the target 102 is calculated as:

$$( \frac{c}{2} ) [ ( {t}_{2} - {t}_{1} ) + [ ( {t}_{3} - {t}_{2} ) + ( {t}_{4} - {t}_{3} ) ] ( \frac{1}{{n}_{220}} ) + ( {t}_{5} - {t}_{4} ) ] ,$$

where n₂₂₀ is the index of refraction for the medium 220.

The purpose of this illustration is merely to provide a simple exemplary time of flight calculation of optical energy through one medium 210 and the spectral return from another medium 220. Other calculations may include the distance between the LIDAR system 100 and the interface 221 as exemplarily illustrated below. Additionally, the BSCE 202 may start at the interface 221 between the two mediums 210 and 220 or at some distance within the medium 220, also illustrated below.

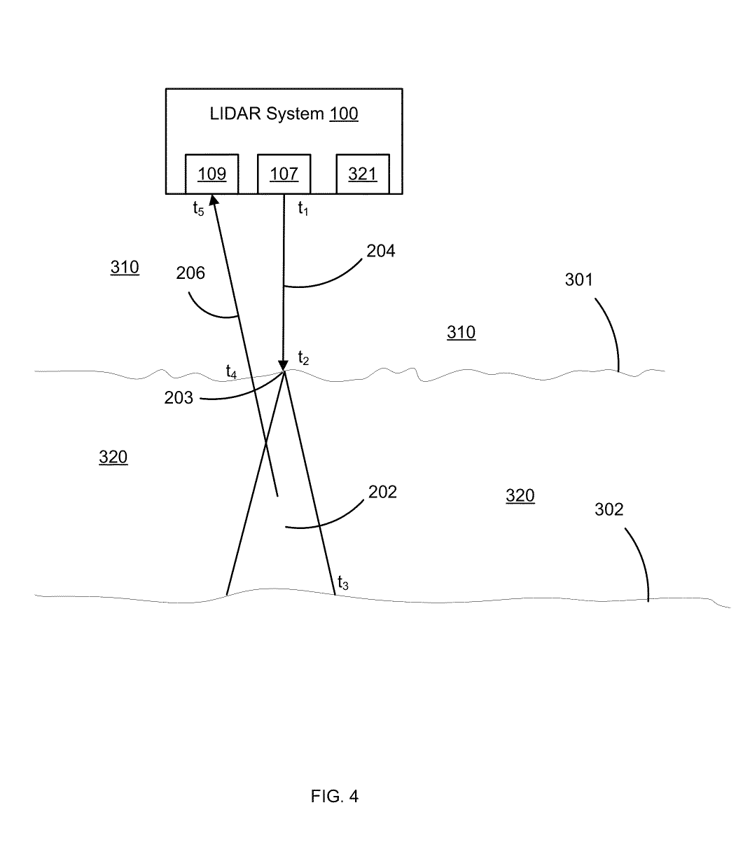

FIG. 4 is a block diagram of the LIDAR system 100 operable to determine a range parameter in water 320 to provide a bathymetric measurement in one exemplary embodiment. In operation, the LIDAR system 100 is positioned above the water (e.g., on a boat or a plane) and is operable to emit narrow band USP laser pulses along the path 204 toward the body of water 320. As the laser pulses strike the water surface 301, optical energy of the pulses is reflected to the LIDAR system 100. Additionally, some of the optical energy of the pulses passes through the water surface 301 where the BSCE 202 is formed at the reference point 203 at the water surface 301 or some distance below. For example, a laser may be controlled to trigger the BSCE 202 by the various nonlinear effects described above. At this point, the BSCE 202 may be emitted toward the floor 302 of the water 320 (e.g., an ocean floor or the like). The BSCE 202 is subsequently detected by the LIDAR system 100 as the spectral return 206.

The optical energy 206 of the BSCE 202 arrives at the LIDAR system 100 at a wavelength that is different from the wavelength of the transmitted laser pulses. For example, the BSCE 202 may generate plasma in the water 320 that emits optical energy at a wavelength that differs from the laser pulses that are transmitted (e.g., at wavelengths ranging between 300 and 800 nm). The LIDAR system 100 may use the difference in arrival times between the transmitted pulses (path 204) and the spectral return 206 to determine the depth of the water 320 based on different wavelengths.

To illustrate, the laser 107 may fire a USP laser pulse into the water 320 along the path 204 at time t₁. At time t₂, the laser pulse triggers the onset of the BSCE 202 which propagates through the water 320 until it reaches the floor 302 of the water 320. The floor 302 reflects optical energy from the BSCE 202 at a time t3 and the detector 109 receives the optical energy, or a portion thereof (e.g., due to attenuation) along the path 206 at the time t5. Assuming that the USP laser pulse was propagating along the paths 204 and 206 in a vacuum, the distance from the LIDAR system 100 to the floor 302 of the water 320 would simply be: (t₅−t₁)c/2, where again c is the speed of light. However, the speed of USP laser pulse changes or “slows down” in the water 320 so the standard distance calculation is not applicable.

To compute how much the USP laser pulse slows down within the water 320 depends on several factors, such as the salinity of the water 320, the average compositional makeup of the water 320 (e.g., turbidity), alkalinity of the water 320, etc. If these factors are unknown, then it may not be possible to determine the distance between the LIDAR system 100 and the water floor 320. The detector 109 is operable to detect and identify multiple wavelengths of light so as to accurately determine such features. For example, when a USP laser pulse fired by the laser 107, it may initiate the generation of the BSCE 202, which as mentioned has significant spectral components. These different spectral shifts generally result from the USP laser pulse interaction with the material through which the laser pulse propagates. That is, a USP laser pulse at one wavelength impinging a particular material may cause the back scattering of optical energy at another known wavelength. Thus, when the detector 109 receives that back scattered optical energy, the LIDAR system 100 may identify that material. And, when that material is identified, the detector 109 may use the known speed of light constant for that material (i.e., the index of refraction) to determine the range parameter between the LIDAR system 100 and the water floor 302. In this regard, the distance between the LIDAR system 100 and the water floor 302 may be roughly computed as:

$$( \frac{c}{2} ) [ ( {t}_{2} - {t}_{1} ) + [ ( {t}_{3} - {t}_{2} ) + ( {t}_{4} - {t}_{3} ) ] ( \frac{1}{{n}_{320}} ) + ( {t}_{5} - {t}_{4} ) ] ,$$

where n₃₂₀ is the index for refraction of the water 302 as identified by the wavelength of the optical energy 206 via the detector 109. It should be noted that this is a rough measurement that does not take into consideration the distance between the surface 301 and the onset of the BSCE 202 at the reference point 203. This range determination of distance, however, is merely intended as an exemplary illustration as the generation of the BSCE 202 may be controllably determined and accounted for in more detailed calculations.

Additionally, the invention is not intended to be limited to any particular form of BSCE 202 generation as higher order nonlinear effects may balance the self-focusing effect of the USP laser pulse and cause the BSCE 202 to form via nonlinear mixing processes in the water 320 without the above mentioned balanced self-focusing and defocusing processes. In this regard, the BSCE 202 may automatically form and therefore eliminate the need to dynamically focus the laser beam into the water 320. For example, one may take into consideration the air 310/water 320 interface at the surface 301 to configure the laser 107 as the power thresholds for the BSCE 202 are much lower for the water 320 than they are for the air 310. Thus, a laser pulse may be propagated through the air 310 without any significant nonlinear propagation effects. Within the water 320, however, the pulse is well above the power threshold for the BSCE 202. Accordingly, no detailed chirping or focus control is required to cause the BSCE 202 to occur just below the water surface 301.

Additionally, since the BSCE 202 is directed in a cone emission pattern, where frequency components can be mapped to a specific emission angle, the spectrum of the BSCE 202 may also provide some spatial information (i.e., due to angular correction). For example, if there is a spectral shift in the return of optical energy when the beam direction is changed, then additional spatial resolution can be extracted for ranging of deeper targets.

In one embodiment, individual pulses are georeferenced in order to obtain an accurate bathymetric measurement. For example, the LIDAR system 100 may be configured with a Global Positioning System (GPS) 321 that measures the position of the LIDAR system 100 (e.g., aboard an aircraft, a ship, or other vehicle) such that the position of the LIDAR system 100 may be associated with each pulse making a range measurement. Alternatively or additionally, the LIDAR system 100 may include an Inertia Measuring Unit (IMU) operable to determine the angular orientation of the LIDAR system 100. The LIDAR system 100 may use information received from the GPS and/or IMU devices to establish the georeference of each pulse transmitted by the LIDAR system 100 and use the range data to generate detailed bathymetric mapping information. In one embodiment, the detector 109 may record intensity data of the returned light across an entire spectrum of interest. The LIDAR system 100 may then use this data to create a multidimensional hyperspectral map, which consists of spectral data for individual mapping points that cover a region of interest.

The underwater optical frequency generation techniques described herein may be useful in other applications as well. For example, it may be possible to obtain information about the health of distant organisms because healthy plants generally absorb red light whereas unhealthy plants generally reflect red light. Furthermore, the optical frequency generation techniques described herein may be useful in military applications, such as mine or other submersible detection. The LIDAR system 100 may also be useful in determining the chemical analysis of a body of water. For example, some regions of the water 320 may for whatever reason have concentrations of materials that are more predominant than other regions. As the LIDAR system 100 is operable to identify a material according to wavelength (e.g., based on the spectral return from the BSCE 202 through a process generally known as laser induced breakdown spectroscopy) and make a range determination, the LIDAR system 100 may be operable to map the material concentration in the water 320. In this regard, one advantageous use of the LIDAR system 100 would be the ability to identify the geographic size of an oil spill in the water 320.

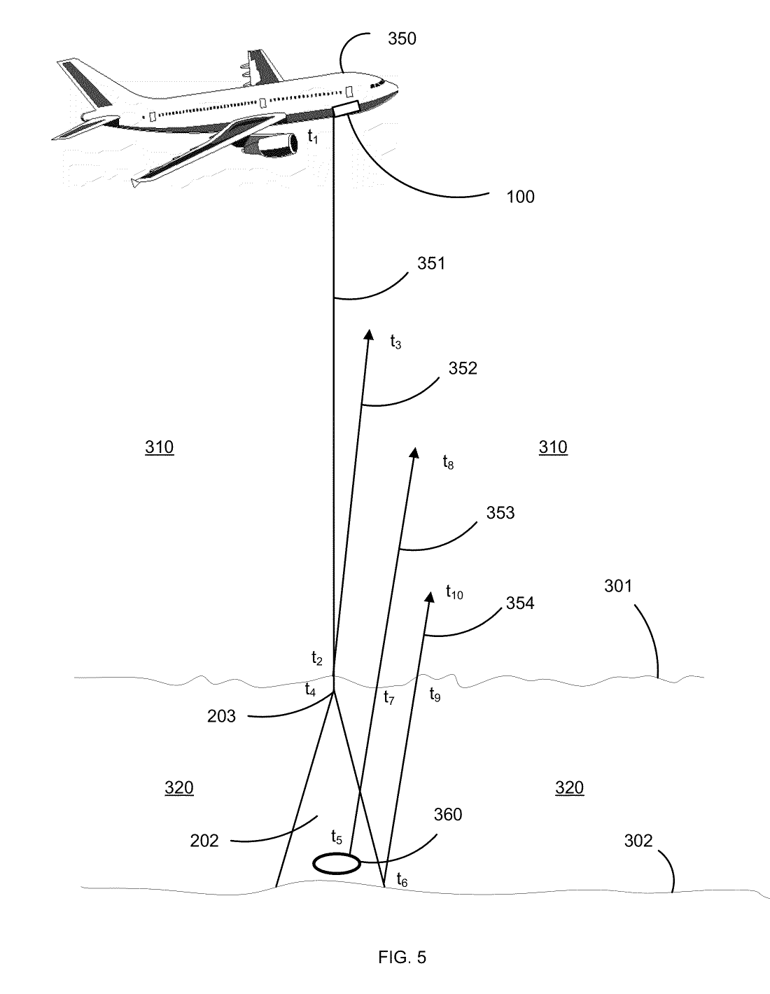

FIG. 5 is an illustration of the LIDAR system 100 in operation aboard an aircraft 350, in one exemplary embodiment. In this embodiment, the LIDAR system 100 fires a laser pulse through the air 310 (a first medium) at the time t₁ along the path 351 into the water 320 (a second medium). The laser pulse impinges the surface 301 of the water 320 at the time t₂ which in turn reflects a portion of the optical energy of the laser pulse to the LIDAR system 100 aboard the aircraft 350. The LIDAR system 100 receives the reflected pulse 352 at the time t₃. A portion of the optical energy from the laser pulse propagates through the surface 301 of the water 320 where it initiates the generation of a BSCE 202 at the reference point 203 and at the time t₄.

The distance of the reference point 203 may vary based on the laser used to generate the laser pulse. For example, if the compositional makeup of the water 320 is known, the depth at which the BSCE 202 forms below the water 320 may also be known for a certain laser. Of course, the invention is not intended to be limited to any particular depth where the BSCE 202 initiates as the laser may be configured to initiate the formation of the BSCE 202 at a number of depths below the surface 301 of the water 320 or even at the surface 301.

In this embodiment, the BSCE 202 propagates through the water 320 in a cone shape until it impinges the floor 302 at the time t₆. While propagating through the water 320, a portion of the optical energy of the BSCE 202 impinges a submerged target 360 at the time t₅ and reflects that optical energy to the LIDAR system 100 along the path 353 where it is received by the LIDAR system 100 at the time t₈. The portion of the BSCE 202 not reflected from the object 360 impinges the floor 302 of the water 320 at the time t₆ where it reflects to the LIDAR system 100 at the time t₆. The LIDAR system 100 receives the resulting spectral return 354 from the floor 108 at the time t₁₀.

With the optical energies received, the LIDAR system 100 may process them to determine the distance between the LIDAR system 100 and the object 360 as well as the object's depth below the surface 301 of the water 320. For example, the distance of the LIDAR system 100 from the surface 301 is simply:

$$( \frac{c}{2} ) ( {t}_{3} - {t}_{1} ) ,$$

where t₃ is associated with the spectral return 352. That distance is essentially the same as c(t₂−t₁), which may now be computed.

The determination of the time t₂−t₁ is relatively important because it may be used to assist in filtering out other optical energy detected by the LIDAR system 100. For example, with the distance between surface 301 and the LIDAR system 100 computed, the distance to the floor 302 may be estimated such that optical energy detected by the detector 109 (see FIG. 1) may be filtered out according to detection times outside the estimated range. That is, optical energy received at times that do not correspond to the distance traveled during the expected time may be removed from any further computations. The distance between the LIDAR system 100 and the water floor 302 may be roughly computed as:

$$( \frac{c}{2} ) [ ( {t}_{2} - {t}_{1} ) + [ ( {t}_{6} - {t}_{4} ) + ( {t}_{9} - {t}_{6} ) ] ( \frac{1}{{n}_{320}} ) + ( {t}_{10} - {t}_{9} ) ] ,$$

where n₃₂₀ again is the index of refraction of the water 320, t₂ is as computed above, and t₁₀ is associated with the spectral return 354.

With the two distances calculated, the depth of the water 320 can now be determined as:

$$( \frac{c}{2} ) [ ( {t}_{2} - {t}_{1} ) + [ ( {t}_{6} - {t}_{4} ) + ( {t}_{9} - {t}_{6} ) ] ( \frac{1}{{n}_{320}} ) + ( {t}_{10} - {t}_{9} ) ] - c ( {t}_{2} - {t}_{1} ) .$$

The distance to the object 360 may be calculated as:

$$( \frac{c}{2} ) [ ( {t}_{2} - {t}_{1} ) + [ ( {t}_{5} - {t}_{4} ) + ( {t}_{7} - {t}_{5} ) ] ( \frac{1}{{n}_{320}} ) + ( {t}_{8} - {t}_{7} ) ] - c ( {t}_{2} - {t}_{1} ) .$$

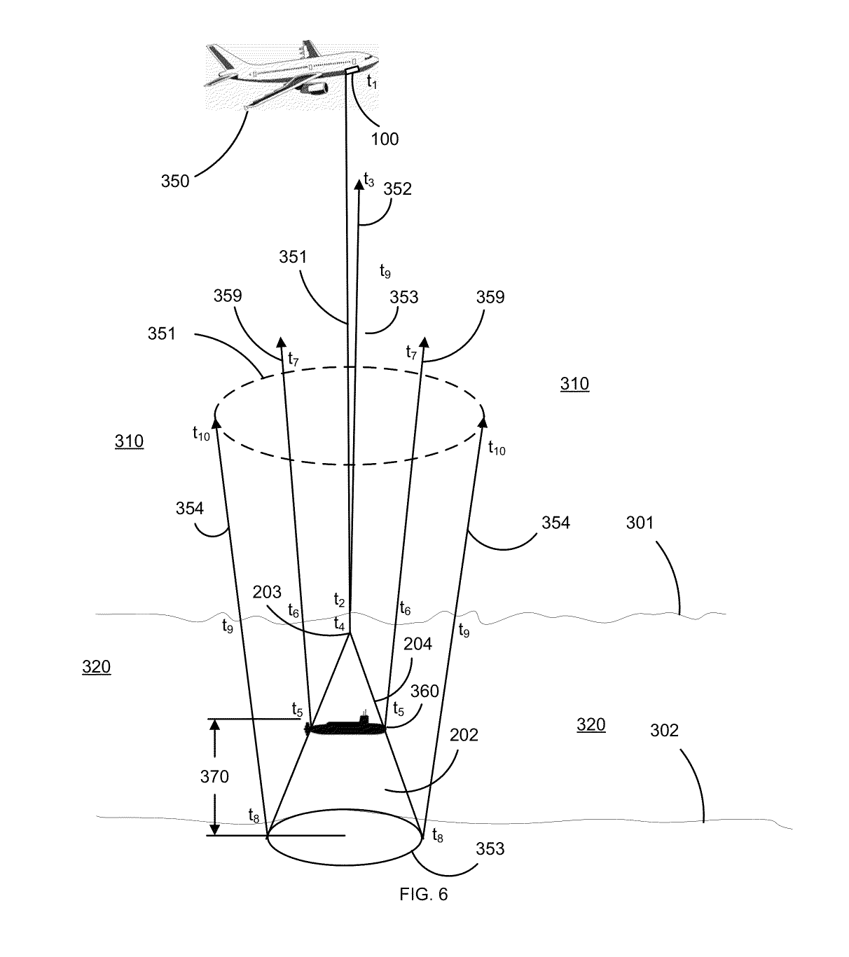

Similar to the rationale in the computation of the distance to the floor 302 involving the determination of the time t₈, the expected time for the spectral return from the object 360 may be used to filter out other returned optical energy. It should be noted that these calculations are merely exemplary and that certain other factors may be used to refine the measurements. For example, the conical shape of the BSCE 202 may be computed to adjust for the return measurements from the floor 108. An example of such is illustrated in FIG. 6. In this regard, the times t₁ through t₁₀ are not necessarily limited to the exact iteration of the reference numbers.

Additionally, the distance between the reference point 203 of the BSCE 202 and the surface 301 may already be determined based on the type of laser being used in the measurement. For example, the laser may be configured to form the BSCE 202 at the surface 301 of the water 320. Alternatively, the laser may generate the BSCE 202 at some predetermined depth therebelow such that it is not necessary to calculate the distance as:

$$c ( {t}_{4} - {t}_{2} ) ( \frac{1}{{n}_{320}} ) .$$

It should also be noted that the angles of the spectral returns 352, 353, and 354 are exaggerated for the purposes of illustration.

FIG. 6 is a more detailed illustration of the LIDAR 100 system in operation aboard the aircraft 350, in one exemplary embodiment. In this embodiment, the LIDAR system 100 fires a laser pulse at the time t₁ to the water 320 in a manner similar to that described above. A portion of the optical energy from the laser pulse reflects from the surface 301 at the time t₂ where it is received by the LIDAR system 100 at the time t₃. That distance is computed as c(t₂−t₁), as described above. The distance to the floor 302 may be calculated (i.e., without respect to the conical shape of the BSCE 202) in this example as:

$$( \frac{c}{2} ) [ ( {t}_{2} - {t}_{1} ) + [ ( {t}_{8} - {t}_{4} ) + ( {t}_{9} - {t}_{8} ) ] ( \frac{1}{{n}_{320}} ) + ( {t}_{10} - {t}_{9} ) ]$$

The distance of the target 360 (in this instance a submarine and without respect to the conical shape of the BSCE 202) from the LIDAR system 100 may be calculated as:

$$( \frac{c}{2} ) [ ( {t}_{2} - {t}_{1} ) + [ ( {t}_{5} - {t}_{4} ) + ( {t}_{6} - {t}_{5} ) ] ( \frac{1}{{n}_{320}} ) + ( {t}_{7} - {t}_{6} ) ] .$$

Thus, the distance 370 of the target 360 (in this instance a submarine) from the floor 302 may be calculated as:

$$( \frac{c}{2} ) [ ( {t}_{10} - {t}_{9} ) - ( {t}_{7} - {t}_{6} ) + [ ( {t}_{8} - {t}_{4} ) + ( {t}_{9} - {t}_{8} ) - ( {t}_{5} - {t}_{4} ) + ( {t}_{6} - {t}_{5} ) ] ( \frac{1}{{n}_{320}} ) ] .$$

In one embodiment, the cone shape of the BSCE 202 may be operable to provide certain imaging features of the object 360. For example, as the BSCE 202 propagates through the water 320 in a general cone shape, the BSCE 202 may encompass the object 360 such that optical energy reflects off the object 360 from different locations and different depths. Accordingly, the optical energy may return to the LIDAR system 100 from the object 360 at different times so to provide a depth analysis of the object 360. With certain filtering algorithms, the LIDAR system 400 may be operable to extract an image of the object 360 within the water 320. For example, the LIDAR system 100 may be operable to detect a submarine. As the submarine may have an expected depth profile, a filtering algorithm may be configured for the submarine such that the LIDAR system 100 may remove a portion of returned optical energy (e.g., optical energy returned from the floor 302) so as to extract the depth profile of the submarine.

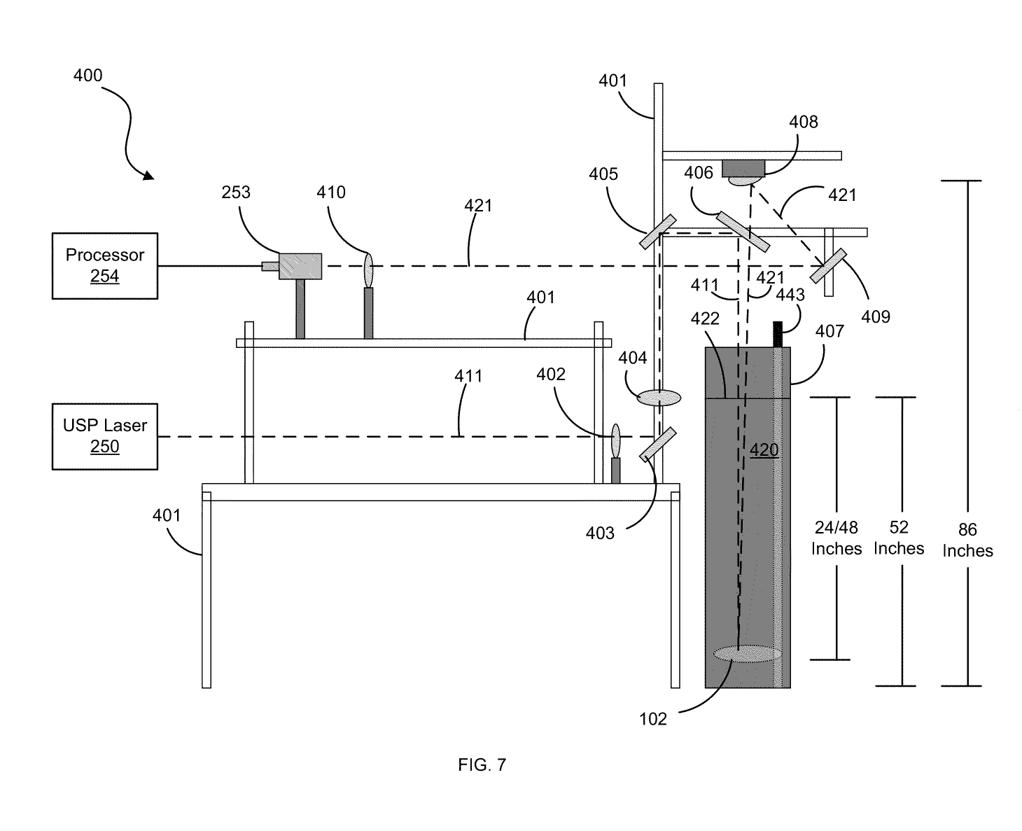

FIG. 7 is a block diagram of an experimental LIDAR system 400. The LIDAR system 400 includes: the USP laser 250; a 3 inch lens 402 with a focal length of +70 cm; a 3 inch mirror 403 that is reflective at 800 nm; a 3 inch lens 404 with a focal length of −60 cm; a 3 inch mirror 405 that is reflective at 800 nm; a 4 inch square mirror 406 that is reflective at 800 nm; a 4 inch off axis parabolic mirror 408; a 4 inch silvered mirror 409; a 2 inch lens 410 with a focal length of +15 cm; the monochromator 253, and the processor 254. In this experiment, the laser 250 is operable to fire USP laser pulses at a wavelength of about 800 nm along the path 411 into the tank 407 to detect the target 102 submerged in the water 420 within the tank 407. The optical elements 402, 403, 404, 405, and 406 direct and impart certain optical features on the laser pulses such that a BSCE (not shown for the purpose of simplified illustration) forms at or below the surface 422 of the water 420. The optical elements 408, 409, and 410 direct the spectral return from the target 102 along the path 421 and impart optical features on the spectral return (e.g., focus the returned optical energy to the monochromator 253). The monochromator 253 detects the spectral return to convert it into data that may be processed by the processor 254. The processor 254, in turn, is operable to determine the range parameter of the target 102 within the water 420 as described above.

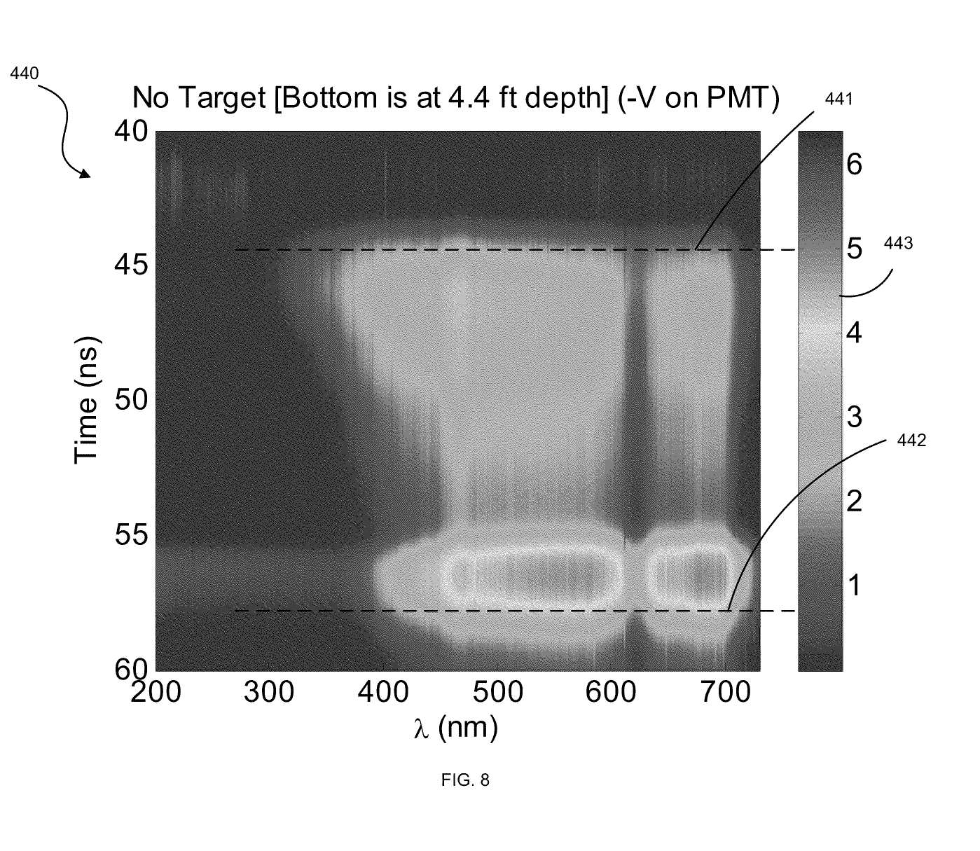

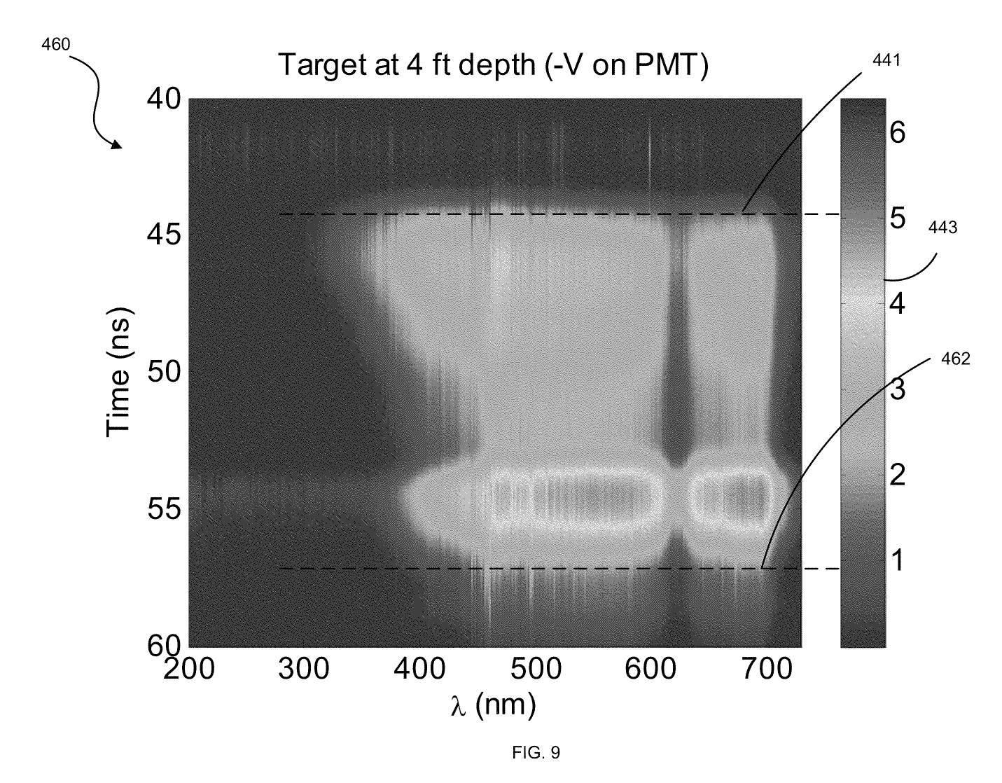

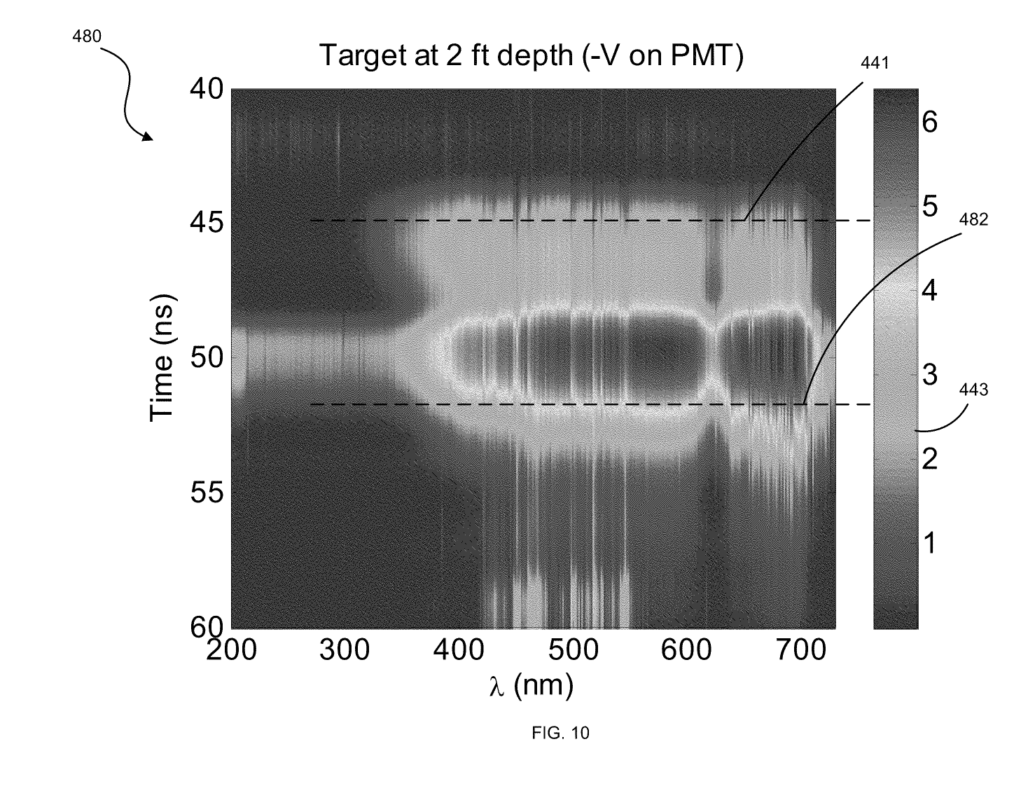

In this experimental embodiment, the target 102 was a sheet of aluminum flashing positioned at depths of 24 inches (see FIG. 10) and 48 inches (see FIG. 9) within the tank 407. The depth of the water 420 from the surface 422 to the bottom of the tank 407 was 52 inches. As mentioned, the USP laser 250 fires laser pulses into the water 420 to form a BSCE such that optical energy from the target 102 is returned for detection by the monochromator 253. The graphs 440, 460, and 480 of FIGS. 8-10, respectively, illustrate the results of this experiment. More specifically, the graph 440 of FIG. 8 illustrates the processed spectral return from bottom of the tank 407 without the target 102 to determine the depth of the water 420 within the tank 407. The surface 422 of the water 420 is illustrated by the illumination at the line 441 (at the range of wavelengths of approximately 350 nm to 730 nm). That is, the optical energy from the laser pulses reflected off the surface 422 of the water 420 and returned to the monochromator 253 at roughly 45 ns. Since the path length from the USP laser 252 and the monochromator 253 is known, the time of the optical energy reflecting from the surface 422 verifies the time of flight/distance calculations. The line 442 illustrates illumination at the bottom of the tank 407 at wavelengths of about 400 nm to 700 nm. The spectral return from the BSCE in the water 420 resulting from the laser pulses returns to the monochromator 253 at roughly 58 ns. Since the index of refraction and the depth of the tank 407 are known, the time of flight of the optical energy from the bottom of the tank 407 verifies the time of flight/distance calculations, which may be computed as roughly 52 inches (see e.g., the distance indicator 443 and the distance between the illumination lines 443 and 442 equaling 5 feet−1 feet). The graph 460 of FIG. 9 illustrates the LIDAR system 400 detecting the target 102 at a depth of roughly 4 feet as indicated by the illumination line 462 and the distance indicator 443. The graph 480 of FIG. 10 illustrates the LIDAR system 400 detecting the target 102 at a depth of roughly 2 feet as indicated by the illumination line 482 and the distance indicator 443.

While one type of laser system for use in LIDAR has been shown and described, the invention is not intended to be so limited as other types of lasers may be used. Additionally, although shown and generally described with respect to the ranging being performed in water, such as an ocean, the invention is not intended to be so limited. For example, the laser detection and ranging may be used in virtually any environment in which optical energy may propagate. For example, the optical energy may propagate through a gaseous environment and form a BSCE along the path of propagation. Based on returned optical energy and travel times, locations of different types of gases/materials may be detected along the path because the wavelength of the returned optical energy changes.

In one embodiment, the laser system 107 is operable to generate optical filaments through a first medium to generate a BSCE 202 in a second medium. Generally, an optical filament is a substantially non-diffracting intense optical feature within an optical beam that can propagate over relatively long distances through a medium. For example, when a beam of relatively high intensity light passes through a gas, the gas reacts and the beam of light begins to self-focus. The beam may focus such that the optical intensity increases significantly and the gas ionizes to form plasma. The resulting plasma tends to defocus the beam. By balancing self-focusing with the defocusing effects of the plasma, one can generate an optical filament that propagates over greater distances. Additionally, optical filaments may generate significant plasma densities having lifetimes that far exceed the optical filament pulse lengths (i.e., durations). Optical filaments are further described in the commonly owned and co-pending U.S. patent application Ser. No. 11/357,701 (filed Feb. 17, 2006), the contents of which are incorporated by reference.

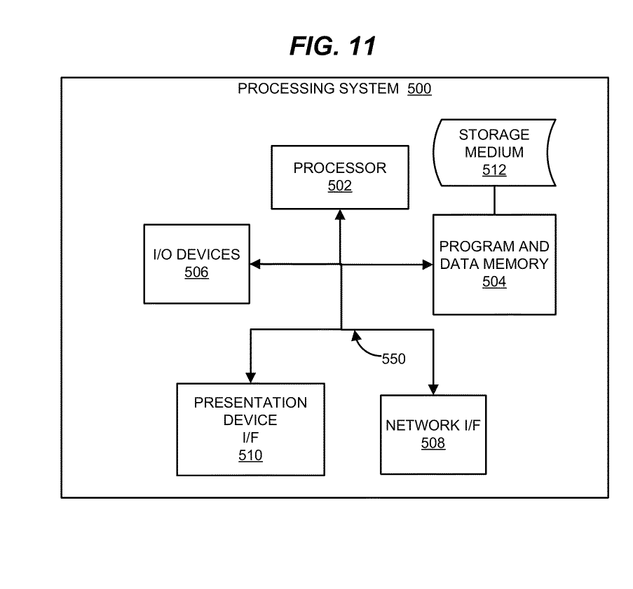

Certain elements of the various embodiments disclosed herein can take the form of software, hardware, firmware, or various combinations thereof. For example, the range parameter processing of the LIDAR system 100 may be implemented by the processing system 500 illustrated in FIG. 11. The processing system 500 may be operable to provide the above features by executing programmed instructions and accessing data stored on a computer readable storage medium 512. In this regard, embodiments of the invention can take the form of a computer program accessible via the computer-readable medium 512 providing program code for use by a computer or any other instruction execution system. For the purposes of this description, the computer readable storage medium 512 can be anything that can contain, store, communicate, or transport the program for use by the computer.

The computer readable storage medium 512 can be an electronic, magnetic, optical, electromagnetic, infrared, or semiconductor device. Examples of the computer readable storage medium 512 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 500, being suitable for storing and/or executing the program code, includes at least one processor 502 coupled to memory elements 504 through a system bus 550. The memory elements 504 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 506 (including but not limited to keyboards, displays, pointing devices, etc) can be coupled to the system 500 either directly or through intervening I/O controllers. Network adapter interfaces 508 may also be coupled to the system to enable the processing system 500 to become coupled to other data processing systems or storage devices through intervening private or public networks. Modems, cable modems, IBM Channel attachments, SCSI, Fibre Channel, and Ethernet cards are just a few of the currently available types of network or host interface adapters. A presentation device interface 510 may be coupled to the processing system 500 to interface to one or more presentation devices, such as printing systems and displays for presentation of presentation data generated by processor 502.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A laser detection and ranging system, including:
a laser operable to fire pulsed optical energy of a first spectrum through a first medium to generate optical energy of a second spectrum after passing through a second medium; and
a detector operable to receive the optical energy of the second spectrum from the second medium to determine a range parameter of the second medium based on a time of flight between the pulsed optical energy and the received optical energy.

2. The laser detection and ranging system of claim 1, wherein the second medium is a liquid.

3. The laser detection and ranging system of claim 2, wherein the liquid is water.

4. The laser detection and ranging system of claim 1, wherein the first medium is air.

5. The laser detection and ranging system of claim 1, wherein the second medium is a gas or an aerosol.

6. The laser detection and ranging system of claim 1, wherein the laser is configured on a boat.

7. The laser detection and ranging system of claim 1, wherein the laser is configured on an aircraft.

8. The laser detection and ranging system of claim 1, wherein the detector is further operable to receive optical energy from the first spectrum.

9. The laser detection and ranging system of claim 1, wherein the detector is further operable to determine a range parameter associated with an interface between the first medium and the second medium.

10. The laser detection and ranging system of claim 1, wherein the range parameter of the second medium includes a depth below a surface of a liquid.

11. The laser detection and ranging system of claim 1, wherein the detector is further operable to detect an object within a liquid based on the range parameter.

12. The laser detection and ranging system of claim 1, wherein the detector is further operable to identify reflected optical energy from a surface of the second medium and identify optical energy returned from beneath the surface of the second medium.

13. The laser detection and ranging system of claim 12, wherein the detector is further operable to determine the range parameter based on the reflected optical energy and the returned optical energy.

14. The laser detection and ranging system of claim 1, wherein the detector is further operable to determine a material composition of the second medium based on the returned optical energy.

15. The laser detection and ranging system of claim 1, further including a position tracking module communicatively coupled to the detector, wherein the detector is further operable to receive position information from the position tracking module and correlate position information with the range parameter to generate mapping information.

16. The laser detection and ranging system of claim 15, wherein the position tracking module utilizes GPS.

17. The laser detection and ranging system of claim 1, wherein the pulsed optical energy is configured as laser pulses having pulse widths of at least 10 femtoseconds.

18. The laser detection and ranging system of claim 1, wherein the optical energy of the second spectrum includes broadband continuum emissions.

19. The laser detection and ranging system of claim 1, wherein the optical energy of the second spectrum includes harmonic emissions.

20. The laser detection and ranging system of claim 1, wherein the optical energy of the second spectrum includes third harmonic emissions.

21. The laser detection and ranging system of claim 1, wherein the pulsed optical energy is configured as laser pulses with pulse widths in a range of about 1.4 um and 1.8 um.

22. The laser detection and ranging system of claim 1, wherein the pulsed optical energy is configured within a wavelength range between about 700 and 900 nm.

23. The laser detection and ranging system of claim 1, wherein the pulsed optical energy is configured within a wavelength of at least 400 nm.

24. The laser detection and ranging system of claim 1, wherein the detector is a multispectral detector operable to measure spectral data as a function of time.

25. The laser detection and ranging system of claim 1, wherein the detector is a hyperspectral detector operable to measure spectral data as a function of time.

26. The laser detection and ranging system of claim 1, wherein the detector is operable to measure spectral data as a function of position

27. The laser detection and ranging system of claim 1, wherein the detector is further operable to characterize the second medium based on received optical energy.

28. The laser detection and ranging system of claim 27, wherein the received optical energy includes spectral attenuation information of the pulsed optical energy.
